(19) United States
(12) Patent Application Publication
(10) Pub. No.: US 2003/0220441 A1
(43) Pub. Date: Nov. 27, 2003

(54) Ink-receptive surface coating for substrates and method

(76) Inventor: Neil Loeb, Carbondale, CO (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/376,414

(22) Filed: Feb. 28, 2003

Related U.S. Application Data
(60) Provisional application No. 60/360,706, filed on Mar. 1, 2002.

(51) Int. Cl. C08K 3/00; B32B 23/08

(52) U.S. Cl. 524/502; 428/507

(57) ABSTRACT

An ink-receptive coating composition is disclosed comprising at least 5 weight percent of a polymerized vinyl-forming compound; at least 10 weight percent of a pigment-forming compound; at least 10 weight percent of a binder derived from at least one carboxyl group; and at least 0.5 weight percent of an additive selected from the group consisting of surfactants, thickeners, and pH adjusters.

### CROSS-REFERENCES TO RELATED APPLICATIONS

This application claims the benefit of U.S. Provisional Application Serial No. 60/360,706, filed on Mar. 1, 2002, entitled INK-RECEPTIVE SURFACE COATING FOR SUBSTRATES.

### TECHNICAL FIELD

This invention relates to compositions and methods for coating substrates to facilitate printing, and to processes for preparing the same. In particular, the compositions and methods relate to forming, on the surface of a substrate, an ink-receptive layer having a high white point, good ink absorbtivity, good color developability, and that maintains the subtle textures of the substrate.

### BACKGROUND OF THE INVENTION

The applications of digital imaging technologies have grown extensively in recent years. More applications of imaging technology become apparent as the costs of implementing these technologies continue to decline and the complexity of imaging programs increases. These applications range from the relatively commonplace, such as document imaging, to the relatively obscure, such as virtual reality imaging. It is becoming apparent that the market potential of computerized imaging techniques is only just beginning to be recognized.

Among the many existing and potential applications of imaging technologies is the digitized imaging of photographs, paintings, and the like, and facsimiles thereof. Once such images are obtained in digitized form, either by conversion of an analog original or by direct production, as with a computer-aided design (CAD) system, they can be manipulated in a virtually unlimited number of ways. For example, the images can be enhanced with respect to color, contrast or size, and even manipulated onto a different image.

A typical imaging system includes a computer having an adequate storage medium to record the image to be processed, an image production device, such as a scanner, to digitize the original image, an image processor, which is designed to speed up the available image manipulations, and an output device where the processed image is received. Although each of the above-mentioned components of a typical imaging system continues to develop as the technologies advance, the ultimate stage of image processing, specifically, the transfer of a processed image onto a desired medium, is of particular interest herein.

The printers employed in these technologies include dot-impact printers, laser printers, thermal printers, ink-jet printers and the like, of which ink-jet printers and ink-jet plotters are most widely employed because these machines have advantages that include printing that can be performed with little machine noise and in full color. Additionally, the comparatively low cost and convenient use of ink-jet printers make such printers the generally preferred devices for recording processed images. Regrettably, the acceptability of the recorded images produced with ink-jet printers is, quite frequently, extremely dependent on the recording medium. Typically, the recording medium used with an ink-jet printer is paper, which is provided as a plain-type or coated-type paper. However, for many applications, such as for the imaging of paintings or advertisements, paper is not a suitable recording medium. Preferably, alternate recording media or substrate that would be used under these, and other, circumstances include canvases, textiles, leathers, and polymer sheets.

Typically, the substrate used in printing in an ink-jet printer or ink-jet plotter can be coated with an ink-receptive layer, or can include a plastic film recording sheet provided with an ink-receptive layer on at least one surface of the substrate. Recording sheets of this type are widely used in the preparation of posters having colored images because the printed material obtained by printing out on such a recording sheet is in the gloss of the surface. Unfortunately, such ink-receptive layers are transparent and printing is completed on top of the ink-receptive layer, creating in an appearance akin to writing on the surface of a mirror. Moreover, peeling of the ink-receptive layer is often problematic, often resulting in the loss of the entire ink-receptive layer.

Various coating compositions have been proposed heretofore for forming such an ink-receptive layer on a substrate to prepare an ink-jet recording sheet, including, for example, coating compositions comprising a polyvinyl alcohol and polyvinylpyrrolidone. Due to the hydrophilic nature of these polymers, however, the ink-receptive layer has low water-resistance so that use of the recording sheets outdoors or under a highly humid atmosphere is limited along with a disadvantage of blocking of the sheets stacked on one another.

One of the major concerns in using any recording medium is the extent to which the medium permits “print through” of ink and the extent to which the medium resists ink absorption. In the case of “print through,” the ink penetrates through the medium and can readily be perceived from the opposing surface. This is particularly problematic where sizeable amounts of ink are utilized, as in full-color printing. Conversely, whenever the print medium resists ink absorption, blotting or feathering of ink on the surface can occur since the ink is not sufficiently absorbed into the medium.

Commonly, a sizing agent that fills the pores of the recording medium is engaged in an effort to give the medium the desired balance of ink absorptivity and penetration resistance, especially when the medium would otherwise have excessive ink penetration. However, it has been found that sizing agents tend to migrate over time in the recording medium, thereby causing changes in the ink absorptivity of the medium and reducing overall print quality of the recorded image. Moreover, such sizing agents fill the pores, and therefore do not permit the subtle textures of the recording medium or substrate to be maintained.

In other situations, the desired recording medium resists ink penetration excessively, such as with nonporous or coated porous substrates. One example of the latter kind of substrate is that of porous corrugated packages coated with clay-based or other coatings. These particular coatings improve the flexographic printing properties of the packages. A method to correct the poor ink absorptivity for ink-jet printing of these packages involves reformulating the water-based inks to include acrylic-based or alcohol-based formulations. However, reformulating the inks likely would require making adjustments to printheads and other machine components.

Recording materials including a nonporous base material and a surface recording layer formed thereon have been proposed where the surface recording layer purportedly is formed at least with a surface active agent that does not form an insoluble material in the ink, and optionally, is formed with a binder agent which is soluble in or swells in an aqueous ink. The charge of the surface active agent, e.g., cationic, anionic or neutral, in the surface recording layer apparently must be matched with the charge of the dye present in the ink composition.

Although much energy has been expended on adapting paper and paper-like media for use with high-speed printers, such as full-color ink-jet printers, little attention has been paid to either altering low quality substrate materials so as to yield a substrate that mimics the qualities of high quality substrate materials or maintaining the subtle textures of the substrate. Accordingly, it is desired to provide a novel coating for substrates that can be used in conjunction with printers in the offset print, wet print, ink-jet print, ink-coat, and digital imaging industries, in which there is high white point, high ink absorptivity, acceptably low “print-through” characteristics, and yet permits the subtle textures of the substrate to be maintained. In particular, it is desired to provide novel coating prepared for application on such substrates as canvas, textiles, polymeric sheets and films, and paper products. Recording media treated with such a novel coating are expected to offer qualities, such as improved aesthetics, clarity, durability, and the like, typically associated with conventional paper and other fibrous materials of higher quality.

### SUMMARY OF THE INVENTION

The present invention eliminates the above-mentioned needs for a novel coating for substrates that can be used in conjunction with printers in the offset print, wet print, ink-jet print, ink-coat, and digital imaging industries, by providing a coating composition in which there is high white point, high ink absorptivity, acceptably low “print-through” characteristics, and permits the subtle textures of the substrate to be maintained.

In accordance with the present invention, there is provided an ink-receptive coating composition comprising at least 5 weight percent of a polymerized vinyl-forming compound, at least 10 weight percent of a pigment-forming compound, at least 10 weight percent of a binder derived from at least one carboxyl group, and at least 0.5 weight percent of an additive selected from the group consisting of surfactants, thickeners, and pH adjusters.

The present invention is additionally directed to an ink-receptive composition-coated article comprising a substrate layer and a coating layer applied to the substrate layer, the coating layer having a polymerized vinyl-forming compound, a pigment-forming compound, a binder, and an additive selected from the group consisting of surfactants, thickeners, and pH adjusters.

The present invention is further directed to a method for preparing an ink-receptive coating composition, the method comprising the steps of providing a polymerized vinyl-forming compound to a container, providing a pigment-forming compound to the container, providing a binder to the container, providing an additive selected from the group consisting of surfactants, thickeners, and pH adjusters to the container, and mixing the polymerized vinyl-forming compound, pigment-forming compound, binder, and additive selected from the group consisting of surfactants, thickeners, and pH adjusters with a solvent to form the coating composition.

The present invention is yet further directed to a method for coating a substrate with an ink-receptive composition comprising the steps of mixing a polymerized vinyl-forming compound, a pigment-forming compound, a binder, and an additive selected from the group consisting of surfactants, thickeners, and pH adjusters with a solvent to form the coating composition, applying the composition to the substrate, and curing the composition to the substrate.

### BRIEF DESCRIPTION OF THE DRAWINGS

FIG. 1 is a cross-sectional view of the article of the preferred embodiment of the present invention.

FIG. 2 is a magnified cross-sectional view of the preferred embodiment of FIG. 1.

### DETAILED DESCRIPTION OF THE INVENTION

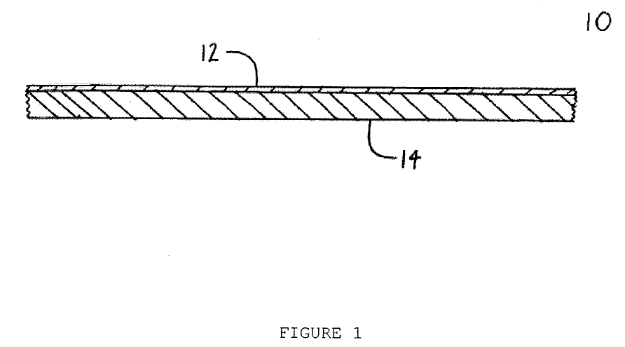

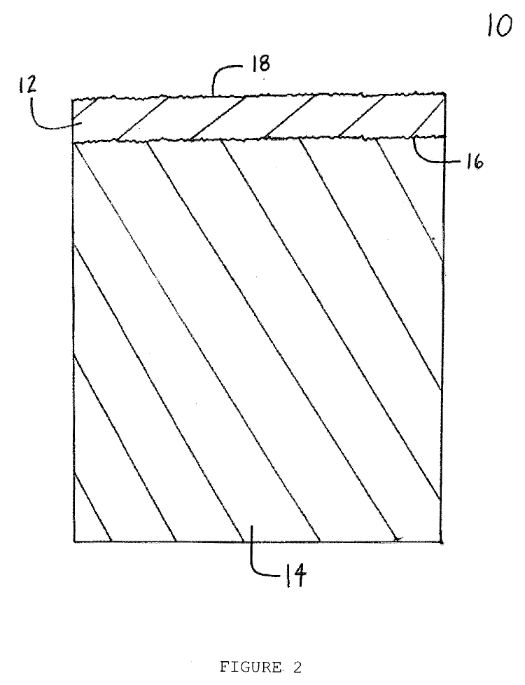

In the preferred embodiment of the present invention, and shown in the accompanying FIGS. 1 and 2, an ink-receptive composition-coated article 10 is disclosed including an ink-receptive layer 12 and substrate layer 14. Ink-receptive layer 12 is made up of an ink-receptive coating composition that comprises at least 5 weight percent of a polymerized vinyl-forming compound, at least 10 weight percent of a pigment-forming compound, at least 10 weight percent of a binder derived from at least one carboxyl group, and at least 0.5 weight percent of an additive selected from the group consisting of surfactants, thickeners, and pH adjusters.

The polymerized vinyl-forming compound is a polyvinyl crystal. Polyvinyl is a water-soluble synthetic polymer with excellent film-forming, emulsifying, and adhesive properties. This adaptable polymer offers outstanding resistance to oil, grease and solvents, plus high tensile strength, flexibility, and high oxygen barrier and is widely used in diverse applications such as: photosensitive coatings; adhesives for paper, wood, textiles, leather and other water-absorbing substrates; as an emulsifier and protective colloid in the production of resin dispersions; textile sizing and finishing; and as binders for pigmented paper coatings, ceramic materials and various fabrics.

The pigment-forming compound includes a clay compound and a titanium dioxide compound. This results in a bright white pigment quite unlike the clear coatings of the prior art and can yield photograph quality paper when applied to poor quality paper, such as brown paper. Moreover, the resulting bright white pigment produces a high print quality surface for any substrate that is of less than optimal quality, including canvases, textiles, papers, polymer films, and the like. The pigment-forming compound produces a pigment coating that has better clarity than the pigment inherent in the less than optimal quality printing substrates. This results in a pigment coat that captures pigment as well. The pigment coat of the present invention avoids the problems inherent with the previous attempts to make poorer quality substrates have the look and function of higher quality substrates, namely, ambering and color shifting of the colors applied to the coated substrate. The present invention prevents ambering and color shifting, thereby creating the appearance of a higher quality substrate.

Moreover, the preferred embodiment of the present invention provides for color saturation that is substantially improved over the coatings of the prior art. The increased color saturation allows for an additional increase in the clarity and sharpness of the displayed image and a greater color gambit to be shown.

The binder includes carbobonds. The carbobonds are derived from carboxyl groups in solution. The binder allows for the ink to bond with the coating composition, so that the ink becomes fixed to the coated substrate.

Furthermore, the coating composition is water-soluble. The water solubility of the coating composition decreases as the coating composition is cured to a substrate.

The substrate can be selected from the group consisting of canvas, textiles, polymeric sheets and films, paper products, and the like. These substrates are of the type typically used in the ink-receptive industries, such as the ink jet industry, the ink coat industry, and the digital picture industry.

The coating composition of the preferred embodiment has a white point greater than that of the substrate to which it is applied. The white point allows for the image that is applied to the composition to have greater clarity and brightness, since the coating composition captures the pigment of the image paced thereon. Thus the coating composition of the present invention eliminates the “mirror writing” appearance inherent in printing on an ink-receptive clear coat. The white point of the present invention is substantially equal to or greater than the white points of high quality printing substrates, thereby increasing clarity and sharpness of the displayed image.

Furthermore, the coating composition of the preferred embodiment has barrier properties to prevent color shift.

Additionally, the coating composition of the preferred embodiment inhibits ultraviolet light reactions. By inhibiting ultraviolet light reactions, the coating composition reduces the amount of fade and color shift of the captured pigment of the image. This permits the image to appear fresh and new longer than with traditional methods, such as applying a clear coat to gesso to receive an ink. Other properties of the coating composition of the preferred embodiment include a brightness of at least 80 lumins and a pH from about 6.5 to about 7.5. The relative neutrality of the pH of the coating composition retards the fading and other properties detrimental to viewing as a result of the age of the printed material.

Moreover, as illustrated in FIG. 2, the preferred ink-receptive layer 12 maintains subtle textures 18 substantially similar to the subtle textures 16 of substrate layer 14. This allows for the perception by the viewer that article 10 containing the ink image (not shown) is, for example, a genuine painting. In this example, the composition does not fill in and even out the irregularities in subtle textures 16 of substrate layer 14, such as are present in canvas. Rather, the composition of the preferred embodiment bonds to the textured surface in such a manner that the textured surface is maintained substantially similar to subtle textures 16 of substrate layer 14, thereby permitting the ink image and coated article 10 to mimic the subtle textures present in an actual painting or other desirable textured print.

In addition, present invention encompasses an embodiment that includes an ink-receptive coating composition having a polymerized vinyl-forming compound, a pigment-forming compound, a binder derived from at least one carboxyl group, and an additive selected from the group consisting of surfactants, thickeners, and pH adjusters.

In practicing the preferred method for preparing an ink-receptive coating composition, the method comprises several steps. One step is the providing of a polymerized vinyl-forming compound to a-container. Another step is the providing of a pigment-forming compound to the container. Yet another step is the providing of a binder derived from at least one carboxyl group to the container. Still another step is the providing of an additive selected from the group consisting of surfactants, thickeners, and pH adjusters to said container. Yet another step is the mixing of the polymerized vinyl-forming compound, pigment-forming compound, binder, and additive selected from the group consisting of surfactants, thickeners, and pH adjusters with a solvent to form the coating composition.

In practicing the preferred method for coating a substrate with an ink-receptive composition, several steps are performed. These steps include the mixing of a polymerized vinyl-forming compound, a pigment-forming compound, a binder derived from at least one carboxyl group, and an additive selected from the group consisting of surfactants, thickeners, and pH adjusters with a solvent to form the coating composition. Another step is the applying of the composition to the substrate. Such application can be accomplished through any one of a number of ways know in the art, including but not limited to knife over roll application and spray application. Yet another step is the curing of the composition to the substrate.

The solvent is selected from the group consisting of water and alcohol.

In the preferred method of the present invention, the coating composition is applied to the substrate by way of a knife over roll application. The knife over roll application process relies on a coating being applied to the substrate, the coating then passing through a space between a knife-like structure and a support roller. As the coating and substrate pass under the knife, the excess coating is scraped off, often for subsequent use. This process can be used for high viscosity coatings and very high coating weights, such as with plastisols and rubber coatings. There are innumerable variants of this process.

In addition, the coating composition can be applied to the substrate by a roller or spray application. Once the coating composition is applied to the substrate, the coating composition is cured. The coating composition can be cured to the substrate by an array of processes, including but not limited to evaporative drying, heat, and light.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. An ink-receptive coating composition comprising:
at least 5 weight percent of a polymerized vinyl-forming compound;
at least 10 weight percent of a pigment-forming compound;
at least 10 weight percent of a binder derived from at least one carboxyl group; and
at least 0.5 weight percent of an additive selected from the group consisting of surfactants, thickeners, and pH adjusters.

2. The coating composition according to claim 1 wherein said coating composition is water-soluble.

3. The coating composition according to claim 2 wherein said water solubility decreases as said coating composition is cured to a substrate.

4. The coating composition according to claim 3 wherein said substrate is selected from the group consisting of canvas, textiles, polymeric sheets and films, and paper products.

5. The coating composition according to claim 1 wherein said polymerized vinyl-forming compound is a polyvinyl crystal.

6. The coating composition according to claim 1 wherein said pigment-forming compound includes a clay compound and a titanium dioxide compound.

7. The coating composition according to claim 1 wherein said binder includes carbobonds.

8. The coating composition according to claim 1 wherein said coating composition has a white point.

9. The coating composition according to claim 1 wherein said coating composition has barrier properties for reducing color shift.

10. The coating composition according to claim 1 wherein said coating composition inhibits ultraviolet light reactions.

11. The coating composition according to claim 1 wherein said coating composition has a brightness of at least 80 lumins.

12. The coating composition according to claim 1 wherein said coating composition has a pH from about 6.5 to about 7.5.

13. The coating composition according to claim 4 wherein said coating composition maintains the subtle textures of said substrate.

14. An ink-receptive composition-coated article comprising:
a substrate layer; and
a coating layer applied to said substrate layer, said coating layer having a polymerized vinyl-forming compound, a pigment-forming compound, a binder derived from at least one carboxyl group, and an additive selected from the group consisting of surfactants, thickeners, and pH adjusters.

15. The composition-coated article according to claim 14 wherein said substrate layer has a textured surface.

16. The composition-coated article according to claim 15 wherein said coating layer maintains subtle textures substantially similar to said textured surface of said substrate layer.

17. The composition-coated article according to claim 14 wherein said substrate is selected from the group consisting of canvas, textiles, polymeric sheets and films, and paper products.

18. The composition-coated article according to claim 14 wherein said coating layer is water-soluble.

19. The composition-coated article according to claim 18 wherein said water solubility decreases as said coating composition is cured to a substrate.

20. The composition-coated article according to claim 14 wherein said polymerized vinyl-forming compound is a polyvinyl crystal.

21. The composition-coated article according to claim 14 wherein said pigment-forming compound includes a clay compound and a titanium dioxide compound.

22. The composition-coated article according to claim 14 wherein said binder includes carbobonds.

23. The composition-coated article according to claim 14 wherein said coating layer has a white point greater than a white point of said substrate layer.

24. The composition-coated article according to claim 14 wherein said coating layer has barrier properties for reducing color shift.

25. The composition-coated article according to claim 14 wherein said coating layer inhibits ultraviolet light reactions.

26. The composition-coated article according to claim 14 wherein said coating layer has a brightness of at least 80 lumins.

27. The composition-coated article according to claim 14 wherein said coating layer has a pH from about 6.5 to about 7.5.

28. A method for preparing an ink-receptive coating composition, said method comprising the steps of:
providing a polymerized vinyl-forming compound to a container;
providing a pigment-forming compound to said container;
providing a binder derived from at least one carboxyl group to said container;
providing an additive selected from the group consisting of surfactants, thickeners, and pH adjusters to said container; and
mixing said polymerized vinyl-forming compound, pigment-forming compound, binder, and additive selected from the group consisting of surfactants, thickeners, and pH adjusters with a solvent to form said coating composition.

29. The method according to claim 28 wherein said polymerized vinyl-forming compound is a polyvinyl crystal.

30. The method according to claim 28 wherein said pigment-forming compound includes a clay compound and a titanium dioxide compound.

31. The method according to claim 28 wherein said binder includes carbobonds.

32. The method according to claim 28 wherein said coating composition has a white point.

33. The method according to claim 28 wherein said coating composition has barrier properties for reducing color shift.

34. The method according to claim 28 wherein said coating composition inhibits ultraviolet light reactions.

35. The method according to claim 28 wherein said coating composition has a brightness of at least 80 lumins.

36. The method according to claim 28 wherein said coating composition has a pH from about 6.5 to about 7.5.

37. A method for coating a substrate with an ink-receptive composition comprising the steps of:
mixing a polymerized vinyl-forming compound, a pigment-forming compound, a binder derived from at least one carboxyl group, and an additive selected from the group consisting of surfactants, thickeners, and pH adjusters with a solvent to form said coating composition;
applying said composition to said substrate; and
curing said composition to said substrate.

38. The method according to claim 37 wherein said polymerized vinyl-forming compound is a polyvinyl crystal.

39. The method according to claim 37 wherein said pigment-forming compound includes a clay compound and a titanium dioxide compound.

40. The method according to claim 37 wherein said binder includes carbobonds.

41. The method according to claim 37 wherein said coating composition has a white point greater than a white point of said substrate.

42. The method according to claim 37 wherein said coating composition has barrier properties for reducing color shift.

43. The method according to claim 37 wherein said coating composition inhibits ultraviolet light reactions.

44. The method according to claim 37 wherein said coating composition has a brightness of at least 80 lumins.

45. The method according to claim 37 wherein said coating composition has a pH from about 6.5 to about 7.5.

46. The method according to claim 37 wherein said solvent is selected from the group consisting of water and alcohol.

47. The method according to claim 37 wherein said composition is applied to said substrate as a spray.

48. The method according to claim 37 wherein said composition is applied to said substrate by a knife over roll applicator.

49. The method according to claim 37 wherein said composition is cured to said substrate by evaporative drying.

50. The method according to claim 37 wherein said composition is cured to said substrate by heat.

51. The method according to claim 37 wherein said composition is cured to said substrate by light.
